(19) United States
(12) Patent Application Publication
(10) Pub. No.: US 2016/0275961 A1
(43) Pub. Date: Sep. 22, 2016

(54) STRUCTURE FOR MULTI-MICROPHONE SPEECH ENHANCEMENT SYSTEM

(71) Applicant: QUALCOMM TECHNOLOGIES International, Ltd., Cambridge (GB)

(72) Inventors: Tao Yu, Rochester Hills, MI (US); Rogerio Guedes Alves, Macomb Township, MI (US)

(21) Appl. No.: 14/662,022

(22) Filed: Mar. 18, 2015

(51) Int. Cl. G10L 21/0208; G10K 11/16

(52) U.S. Cl. CPC G10L 21/0208; G10K 11/16

(57) ABSTRACT

Embodiments are directed towards enhancing speech and noise reduction for audio signals. Each of a plurality of microphones may generate a plurality of audio signals based on sound sensed in a physical space. One of the plurality of audio signals may be designated as a primary channel and each other audio signal of the plurality of audio signals may be designated as secondary channels. Acoustic echo cancellation is performed on the primary channel to generate an echo canceled signal. Noise reduction (e.g., employing a multi-microphone beamformer) is performed on the primary channel and the secondary channels to generate a noise reduced signal. In various embodiments, the noise reduction is performed in parallel with the acoustic echo cancellation. An enhanced audio signal may be generated based on a combination of the echo canceled signal and the noise reduced signal.

### TECHNICAL FIELD

The present invention relates generally to speech enhancement, and more particularly, but not exclusively, to employing acoustic echo cancellation and noise reduction in parallel to provide speech enhancement of an audio signal.

### BACKGROUND

Today, many people use “hands-free” telecommunication systems to talk with one another. These systems often utilize mobile phones, a remote loudspeaker, and a remote microphone to achieve hands-free operation, and may generally be referred to as speakerphones. Speakerphones can introduce—to a user—the freedom of having a phone call in different environments. In noisy environments, however, these systems may not operate at a level that is satisfactory to a user. For example, the variation in power of user speech in the speakerphone microphone may generate a different signal-to-noise ratio (SNR) depending on the environment and/or the distance between the user and the microphone. Low SNR can make it difficult to detect or distinguish the user speech signal from the noise signals. Additionally, a user may change locations during a phone call or the environment surrounding the user may change, which can impact the usefulness of noise cancelling algorithms. Thus, it is with respect to these considerations and others that the invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a network computer that may be included in a system such as that shown in FIG. 1;

FIG. 3 shows an embodiment of a speaker/microphone system that may be included in a system such as that shown in FIG. 1

FIG. 4 shows an embodiment of a voice communication system with bi-directional speech processing between a near-end user and a far-end user;

FIG. 5 illustrates a noise-reduction-first structure for enhancing audio signals;

FIG. 6 illustrates an acoustic-echo-cancelation-first structure for enhancing audio signals;

FIG. 7 illustrates an embodiment of a system that employs acoustic echo cancelation in parallel/simultaneously with noise reduction techniques in accordance with embodiments described herein;

FIG. 8 illustrates an alternative embodiment of a system that employs acoustic echo cancelation in parallel/simultaneously with the noise reduction techniques in accordance with embodiments described herein;

FIG. 9 illustrates an alternative embodiment of a system that employs acoustic echo cancelation in parallel/simultaneously with the noise reduction techniques in accordance with embodiments described herein;

FIG. 10 illustrates an alternative embodiment of a system that employs acoustic echo cancelation in parallel/simultaneously with the noise reduction techniques in accordance with embodiments described herein;

FIG. 11 illustrates an alternative embodiment of a system that employs acoustic echo cancelation in parallel/simultaneously with the noise reduction techniques in accordance with embodiments described herein;

FIG. 12 illustrates an example schematic for employing noise reduction in parallel with acoustic echo cancellation in accordance with embodiments described herein;

FIGS. 13A and 13B illustrate a hands-free headset using embodiment described herein

FIG. 14 illustrates an example use-case environment for employing embodiments described herein;

FIGS. 15A-15C illustrate example alternative use-case environments for employing embodiments described herein;

FIG. 16 illustrates a logical flow diagram generally showing an embodiment of a process for generating an enhanced audio signal by employing AEC and NR in parallel; and

FIG. 17 illustrates a logical flow diagram generally showing an alternative embodiment of a process for generating an enhanced audio signal by employing AEC and NR in parallel.

### DETAILED DESCRIPTION

Various embodiments are described more fully hereinafter with reference to the accompanying drawings, which form a part hereof, and which show, by way of illustration, specific embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media, or devices. Accordingly, the various embodiments may be entirely hardware embodiments, entirely software embodiments, or embodiments combining software and hardware aspects. The following detailed description should, therefore, not be limiting.

Throughout the specification and claims, the following terms take the meanings explicitly associated herein, unless the context clearly dictates otherwise. The term “herein” refers to the specification, claims, and drawings associated with the current application. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

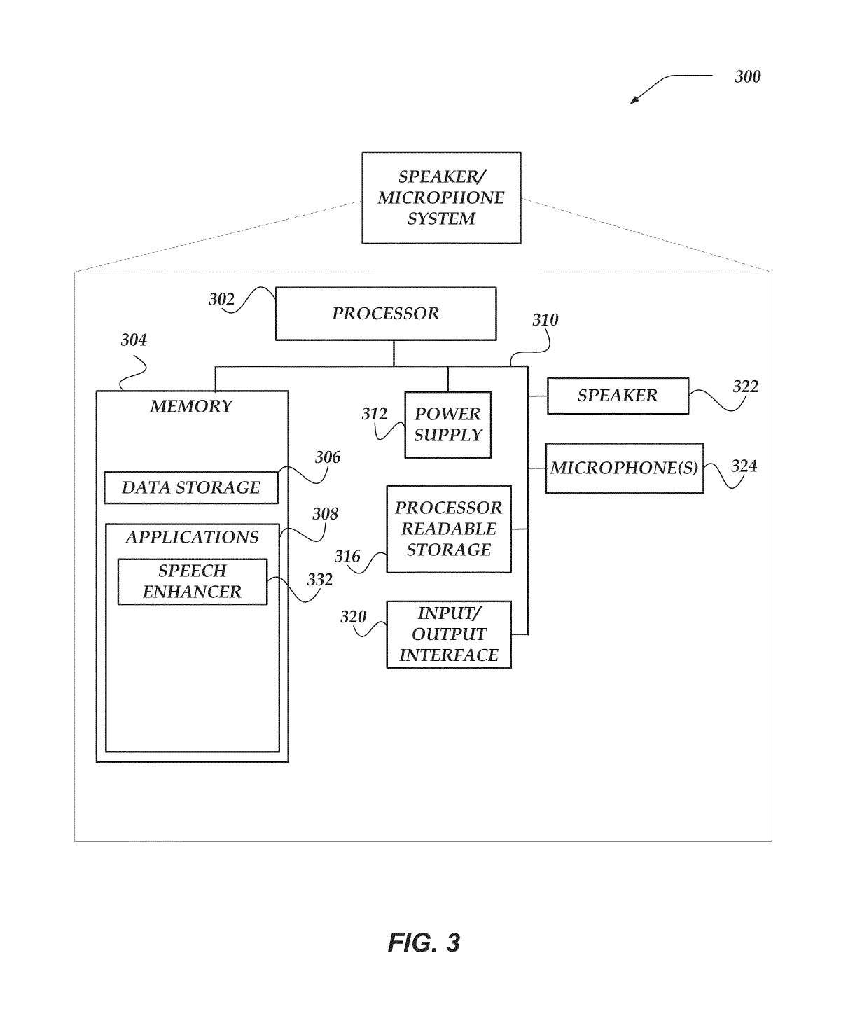

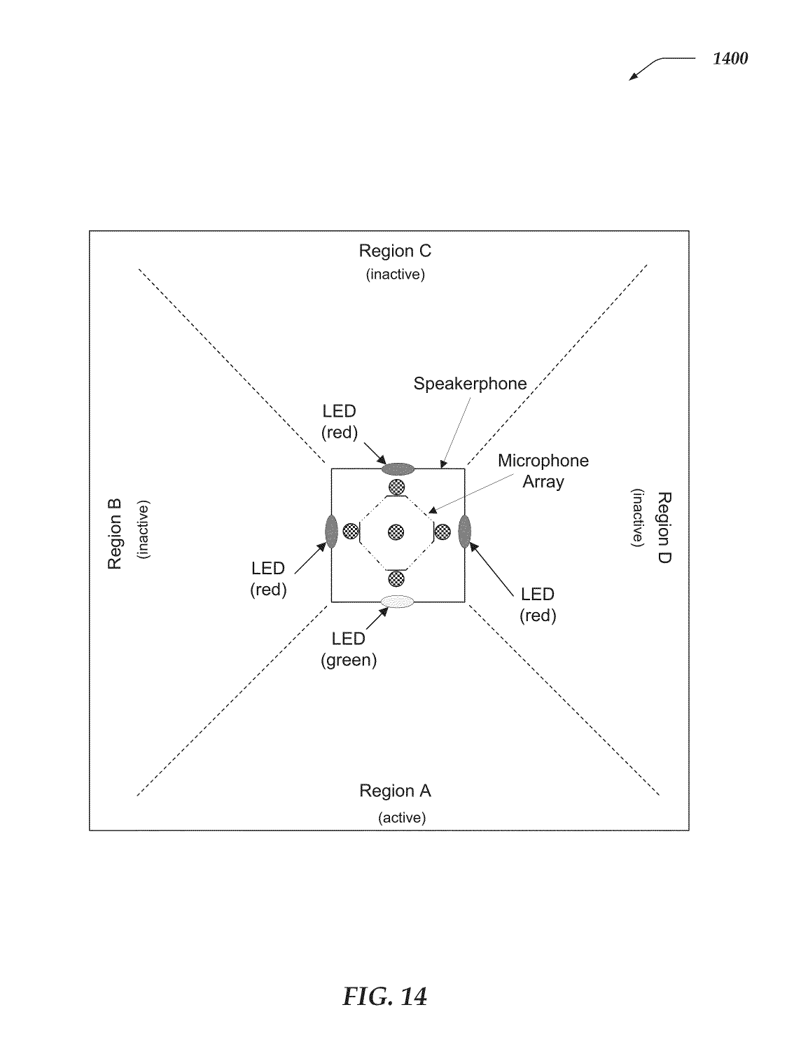

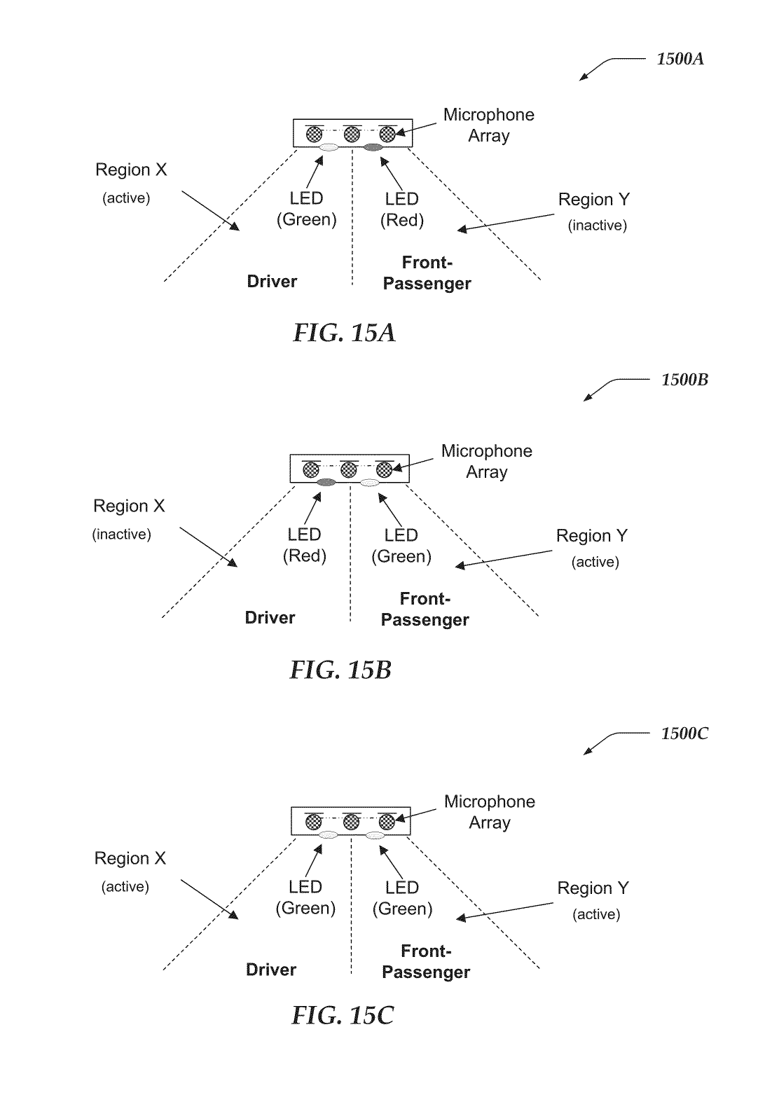

As used herein, the term “speaker/microphone system” refers to a system or device that may be employed to enable “hands free” telecommunications. One example embodiment of a speaker/microphone system is illustrated in FIG. 3. Briefly, however, a speaker/microphone system may include one or more speakers and one or more microphones (e.g., a single microphone or a microphone array). In some embodiments, the speaker/microphone system may include at least one indicator and/or one or more activators, such as described in conjunction with FIGS. 14 and 15A-15C.

As used herein, the term “microphone array” refers to a plurality of microphones of a speaker/microphone system. In some embodiments, each microphone may be positioned, configured, and/or arranged to obtain different audio signals, such as, for example, one microphone may be positioned to capture a user's speech, while another microphone may be positioned to capture environmental noise around the user. In other embodiments, each microphone in the microphone array may be positioned, configured, and/or arranged to conceptually/logically divide a physical space adjacent to the speaker/microphone system into a pre-determined number of regions or zones. In various embodiments, one or more microphone may correspond or be associated with a region.

As used herein, the term “region,” “listening region,” or “zone” refers to an area of focus for one or more microphones of the microphone array, where the one or more microphones may be enabled to provide directional listening to pick up audio signals from a given direction (e.g., active regions), while minimizing or ignoring signals from other directions/regions (e.g., inactive regions). In various embodiments, multiple beams may be formed for different regions, which may operate like ears focusing on a specific direction. In various embodiments, a region may be an active region or an inactive region at a given time. As used herein, the term “active region” refers to a region where those audio signals associated with that region are denoted as user speech signals and may be enhanced in an output signal. As used herein, the term “inactive region” refers to a region where those audio signals associated with that region are denoted as noise signals and may be suppressed, reduced, or otherwise canceled in the output signal. Although the term inactive is used herein, microphones associated with inactive regions continue to sense sound and generate audio signals (e.g., for use in detecting spoken trigger words and/or phrases).

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to enhancing speech and noise reduction for audio signals. Each of a plurality of microphones may generate a plurality of audio signals based on sound sensed in a physical space. One of the plurality of audio signals may be designated as a primary channel and each other audio signal of the plurality of audio signals may be designated as secondary channels. Acoustic echo cancellation is performed on the primary channel to generate an echo canceled signal. Noise reduction (e.g., employing a multi- microphone beamformer) is performed on the primary channel and the secondary channels to generate a noise reduced signal. In various embodiments, the noise reduction is performed in parallel with the acoustic echo cancellation.

An enhanced audio signal may be generated based on a combination of the echo canceled signal and the noise reduced signal. In some embodiments, a gain mapping may be employed on the noise reduced signal compared to the primary channel, such that a combination of the mapped gain with the echo canceled signal generates the enhanced audio signal. In some embodiments, multi-microphone beamformer may be employed for each of a plurality of beam zones. A separate gain mapping may be determined on each output from each multi-microphone beamformer to generate a mapped gain for each beam zone. And a final mapped gain may be selected from the mapped gain for each beam zone based on an active zone in the plurality of beam zones.

In various embodiments, the plurality of microphones may be arranged to logically define a physical space into a plurality of beam zones. In some embodiments, the primary channel may be determined as an audio signal generated from a microphone that corresponds to an active beam zone within the physical space. In other embodiments, the secondary channels may be determined as audio signals are generated by one or more microphones that correspond to inactive beam zones within the physical space.

### Illustrative Operating Environment

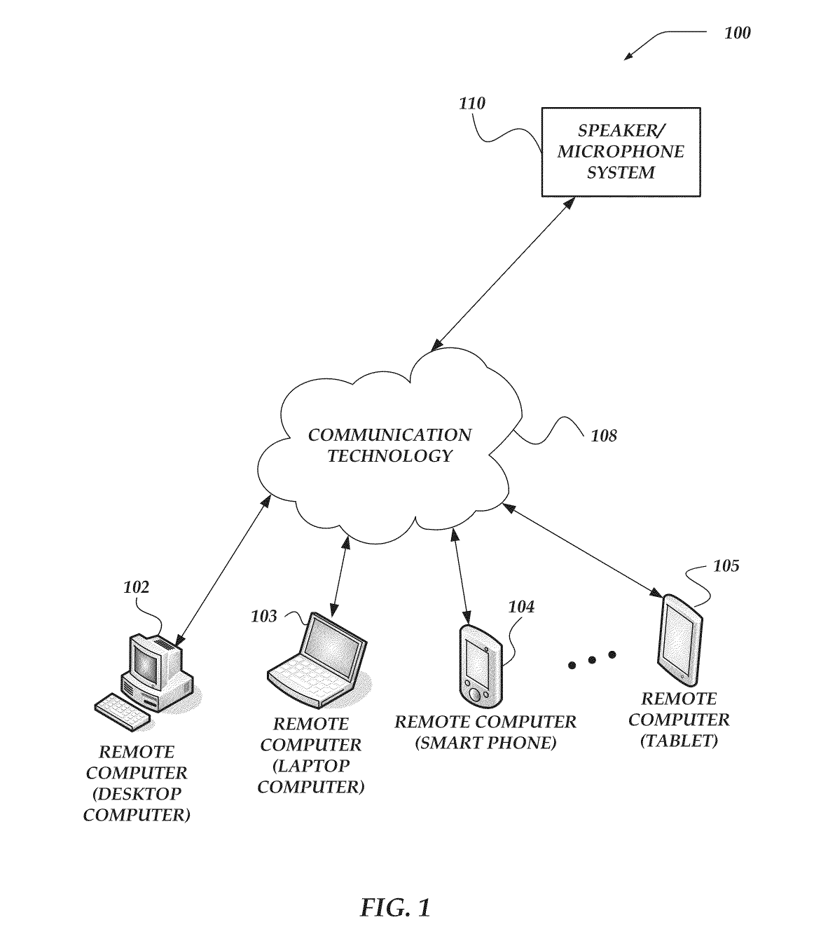

FIG. 1 shows components of one embodiment of an environment in which various embodiments of the invention may be practiced. Not all of the components may be required to practice the various embodiments, and variations in the arrangement and type of the components may be made without departing from the spirit or scope of the invention. As shown, system 100 of FIG. 1 may include speaker/microphone system 110, remote computers 102-105, and communication technology 108.

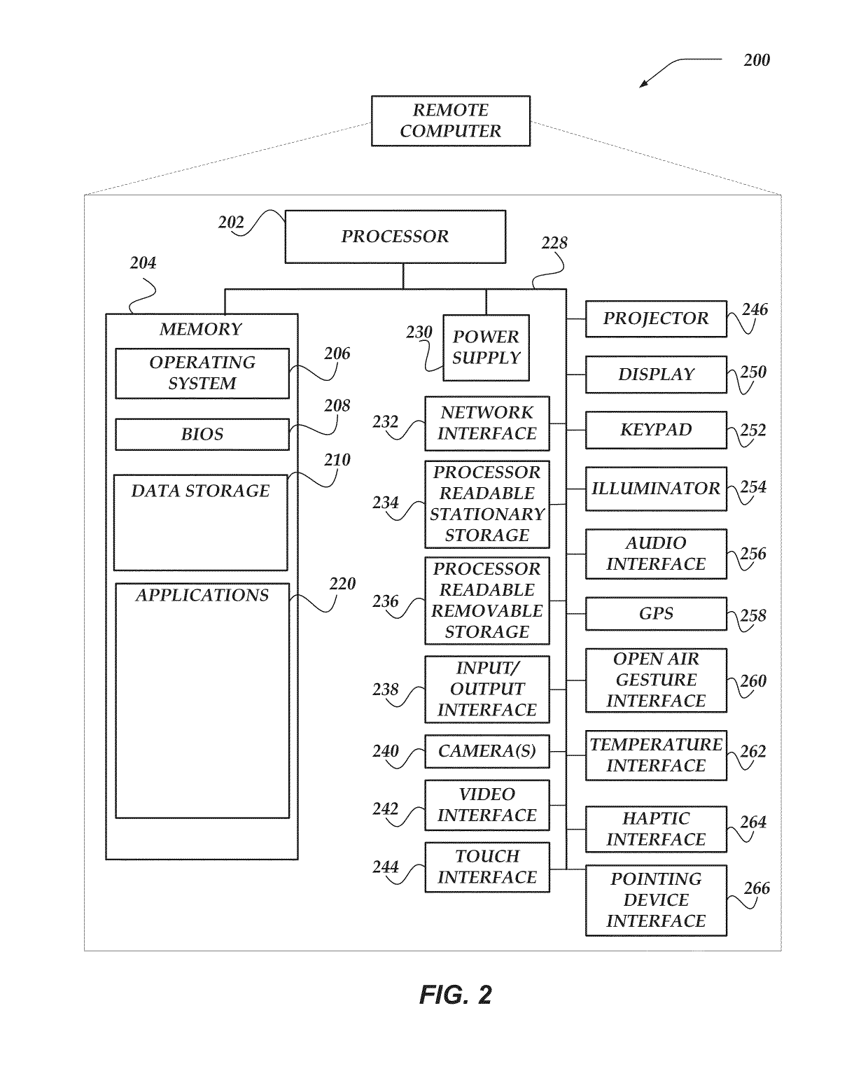

At least one embodiment of remote computers 102-105 is described in more detail below in conjunction with computer 200 of FIG. 2. Briefly, in some embodiments, remote computers 102-105 may be configured to communicate with speaker/microphone system 110 to enable hands-free telecommunication with other devices, while providing listening region tracking with user feedback, as described herein. In other embodiments, a speaker/microphone system embedded may be embedded or otherwise incorporated in remote computers 102-105.

In some embodiments, at least some of remote computers 102-105 may operate over a wired and/or wireless network (e.g., communication technology 108) to communicate with other computing devices or speaker/microphone system 110. Generally, remote computers 102-105 may include computing devices capable of communicating over a network to send and/or receive information, perform various online and/or offline activities, or the like. It should be recognized that embodiments described herein are not constrained by the number or type of remote computers employed, and more or fewer remote computers—and/or types of remote computers—than what is illustrated in FIG. 1 may be employed.

Devices that may operate as remote computers 102-105 may include various computing devices that typically connect to a network or other computing device using a wired and/or wireless communications medium. Remote computers may include portable and/or non-portable computers. In some embodiments, remote computers may include client computers, server computers, or the like. Examples of remote computers 102-105 may include, but are not limited to, desktop computers (e.g., remote computer 102), personal computers, multiprocessor systems, microprocessor-based or programmable electronic devices, network PCs, laptop computers (e.g., remote computer 103), smart phones (e.g., remote computer 104), tablet computers (e.g., remote computer 105), cellular telephones, display pagers, radio frequency (RF) devices, infrared (IR) devices, Personal Digital Assistants (PDAs), handheld computers, wearable computing devices, entertainment/home media systems (e.g., televisions, gaming consoles, audio equipment, or the like), household devices (e.g., thermostats, refrigerators, home security systems, or the like), multimedia navigation systems, automotive communications and entertainment systems, integrated devices combining functionality of one or more of the preceding devices, or the like. As such, remote computers 102-105 may include computers with a wide range of capabilities and features.

Remote computers 102-105 may access and/or employ various computing applications to enable users of remote computers to perform various online and/or offline activities. Such activities may include, but are not limited to, generating documents, gathering/monitoring data, capturing/manipulating images, managing media, managing financial information, playing games, managing personal information, browsing the Internet, or the like. In some embodiments, remote computers 102-105 may be enabled to connect to a network through a browser, or other web-based application.

Remote computers 102-105 may further be configured to provide information that identifies the remote computer. Such identifying information may include, but is not limited to, a type, capability, configuration, name, or the like, of the remote computer. In at least one embodiment, a remote computer may uniquely identify itself through any of a variety of mechanisms, such as an Internet Protocol (IP) address, phone number, Mobile Identification Number (MIN), media access control (MAC) address, electronic serial number (ESN), or other device identifier.

At least one embodiment of speaker/microphone system 110 is described in more detail below in conjunction with computer 300 of FIG. 3. Briefly, in some embodiments, speaker/microphone system 110 may be configured to communicate with one or more of remote computers 102-105 to provide remote, hands-free telecommunication with others.

Speaker/microphone system 110 may generally include one or more microphones and one or more speakers. Examples of speaker/microphone system 110 may include, but are not limited to, Bluetooth soundbar or speaker with phone call support, karaoke machines with internal microphone, home theater systems, mobile phones, or the like.

Remote computers 102-105 may communicate with speaker/microphone system 110 via communication technology 108. In various embodiments, communication technology 108 may be a wired technology, such as, but not limited to, a cable with a jack for connecting to an audio input/output port on remote devices 102-105 (such a jack may include, but is not limited to a typical headphone jack (e.g., 3.5 mm headphone jack), a USB connection, or other suitable computer connector). In other embodiments, communication technology 108 may be a wireless communication technology, which may include virtually any wireless technology for communicating with a remote device, such as, but not limited to, Bluetooth, Wi-Fi, or the like.

In some embodiments, communication technology 108 may be a network configured to couple network computers with other computing devices, including remote computers 102-105, speaker/microphone system 110, or the like. In various embodiments, information communicated between devices may include various kinds of information, including, but not limited to, processor-readable instructions, remote requests, server responses, program modules, applications, raw data, control data, system information (e.g., log files), video data, voice data, image data, text data, structured/unstructured data, or the like. In some embodiments, this information may be communicated between devices using one or more technologies and/or network protocols.

In some embodiments, such a network may include various wired networks, wireless networks, or any combination thereof. In various embodiments, the network may be enabled to employ various forms of communication technology, topology, computer-readable media, or the like, for communicating information from one electronic device to another. For example, the network can include—in addition to the Internet—LANs, WANs, Personal Area Networks (PANs), Campus Area Networks (CANs), Metropolitan Area Networks (MANs), direct communication connections (such as through a universal serial bus (USB) port), or the like, or any combination thereof.

In various embodiments, communication links within and/or between networks may include, but are not limited to, twisted wire pair, optical fibers, open air lasers, coaxial cable, plain old telephone service (POTS), wave guides, acoustics, full or fractional dedicated digital lines (such as T1, T2, T3, or T4), E-carriers, Integrated Services Digital Networks (ISDNs), Digital Subscriber Lines (DSLs), wireless links (including satellite links), or other links and/or carrier mechanisms known to those skilled in the art. Moreover, communication links may further employ any of a variety of digital signaling technologies, including without limit, for example, DS-0, DS-1, DS-2, DS-3, DS-4, OC-3, OC-12, OC-48, or the like. In some embodiments, a router (or other intermediate network device) may act as a link between various networks—including those based on different architectures and/or protocols—to enable information to be transferred from one network to another. In other embodiments, remote computers and/or other related electronic devices could be connected to a network via a modem and temporary telephone link. In essence, the network may include any communication technology by which information may travel between computing devices.

The network may, in some embodiments, include various wireless networks, which may be configured to couple various portable network devices, remote computers, wired networks, other wireless networks, or the like. Wireless networks may include any of a variety of sub-networks that may further overlay stand-alone ad-hoc networks, or the like, to provide an infrastructure-oriented connection for at least remote computers 103-105. Such sub-networks may include mesh networks, Wireless LAN (WLAN) networks, cellular networks, or the like. In at least one of the various embodiments, the system may include more than one wireless network.

The network may employ a plurality of wired and/or wireless communication protocols and/or technologies. Examples of various generations (e.g., third (3G), fourth (4G), or fifth (5G)) of communication protocols and/or technologies that may be employed by the network may include, but are not limited to, Global System for Mobile communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000 (CDMA2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), time division multiple access (TDMA), Orthogonal frequency-division multiplexing (OFDM), ultra wide band (UWB), Wireless Application Protocol (WAP), user datagram protocol (UDP), transmission control protocol/Internet protocol (TCP/IP), any portion of the Open Systems Interconnection (OSI) model protocols, session initiated protocol/real-time transport protocol (SIP/RTP), short message service (SMS), multimedia messaging service (MMS), or any of a variety of other communication protocols and/or technologies. In essence, the network may include communication technologies by which information may travel between remote computers 102-105, speaker/microphone system 110, other computing devices not illustrated, other networks, or the like.

In various embodiments, at least a portion of the network may be arranged as an autonomous system of nodes, links, paths, terminals, gateways, routers, switches, firewalls, load balancers, forwarders, repeaters, optical-electrical converters, or the like, which may be connected by various communication links. These autonomous systems may be configured to self organize based on current operating conditions and/or rule-based policies, such that the network topology of the network may be modified.

### Illustrative Network Computer

FIG. 2 shows one embodiment of remote computer 200 that may include many more or less components than those shown. Remote computer 200 may represent, for example, at least one embodiment of remote computers 102-105 shown in FIG. 1.

Remote computer 200 may include processor 202 in communication with memory 204 via bus 228. Remote computer 200 may also include power supply 230, network interface 232, processor-readable stationary storage device 234, processor-readable removable storage device 236, input/output interface 238, camera(s) 240, video interface 242, touch interface 244, projector 246, display 250, keypad 252, illuminator 254, audio interface 256, global positioning systems (GPS) receiver 258, open air gesture interface 260, temperature interface 262, haptic interface 264, and pointing device interface 266. Remote computer 200 may optionally communicate with a base station (not shown), or directly with another computer. And in one embodiment, although not shown, a gyroscope, accelerometer, or other technology (not illustrated) may be employed within remote computer 200 to measuring and/or maintaining an orientation of remote computer 200.

Power supply 230 may provide power to remote computer 200. A rechargeable or non-rechargeable battery may be used to provide power. The power may also be provided by an external power source, such as an AC adapter or a powered docking cradle that supplements and/or recharges the battery.

Network interface 232 includes circuitry for coupling remote computer 200 to one or more networks, and is constructed for use with one or more communication protocols and technologies including, but not limited to, protocols and technologies that implement any portion of the OSI model, GSM, CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 232 is sometimes known as a transceiver, transceiving device, or network interface card (NIC).

Audio interface 256 may be arranged to produce and receive audio signals such as the sound of a human voice. For example, audio interface 256 may be coupled to a speaker and microphone (not shown) to enable telecommunication with others and/or generate an audio acknowledgement for some action. A microphone in audio interface 256 can also be used for input to or control of remote computer 200, e.g., using voice recognition, detecting touch based on sound, and the like. In some embodiments, audio interface 256 may be operative to communicate with speaker/microphone system 300 of FIG. 3. In various embodiments, audio interface 256 may include the speaker/microphone system such that the speaker/microphone system is embedded, coupled, included, or otherwise a part of remote computer 200.

Display 250 may be a liquid crystal display (LCD), gas plasma, electronic ink, light emitting diode (LED), Organic LED (OLED) or any other type of light reflective or light transmissive display that can be used with a computer. Display 250 may also include a touch interface 244 arranged to receive input from an object such as a stylus or a digit from a human hand, and may use resistive, capacitive, surface acoustic wave (SAW), infrared, radar, or other technologies to sense touch and/or gestures.

Projector 246 may be a remote handheld projector or an integrated projector that is capable of projecting an image on a remote wall or any other reflective object such as a remote screen.

Video interface 242 may be arranged to capture video images, such as a still photo, a video segment, an infrared video, or the like. For example, video interface 242 may be coupled to a digital video camera, a web-camera, or the like. Video interface 242 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 252 may comprise any input device arranged to receive input from a user. For example, keypad 252 may include a push button numeric dial, or a keyboard. Keypad 252 may also include command buttons that are associated with selecting and sending images.

Illuminator 254 may provide a status indication and/or provide light. Illuminator 254 may remain active for specific periods of time or in response to events. For example, when illuminator 254 is active, it may backlight the buttons on keypad 252 and stay on while the mobile computer is powered. Also, illuminator 254 may backlight these buttons in various patterns when particular actions are performed, such as dialing another mobile computer. Illuminator 254 may also cause light sources positioned within a transparent or translucent case of the mobile computer to illuminate in response to actions.

Remote computer 200 may also comprise input/output interface 238 for communicating with external peripheral devices or other computers such as other mobile computers and network computers. The peripheral devices may include a remote speaker/microphone system (e.g., device 300 of FIG. 3), headphones, display screen glasses, remote speaker system, or the like. Input/output interface 238 can utilize one or more technologies, such as Universal Serial Bus (USB), Infrared, WiFi, WiMax, Bluetooth™, wired technologies, or the like.

Haptic interface 264 may be arranged to provide tactile feedback to a user of a mobile computer. For example, the haptic interface 264 may be employed to vibrate remote computer 200 in a particular way when another user of a computer is calling. Temperature interface 262 may be used to provide a temperature measurement input and/or a temperature changing output to a user of remote computer 200. Open air gesture interface 260 may sense physical gestures of a user of remote computer 200, for example, by using single or stereo video cameras, radar, a gyroscopic sensor inside a computer held or worn by the user, or the like. Camera 240 may be used to track physical eye movements of a user of remote computer 200.

GPS transceiver 258 can determine the physical coordinates of remote computer 200 on the surface of the Earth, which typically outputs a location as latitude and longitude values. GPS transceiver 258 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of remote computer 200 on the surface of the Earth. It is understood that under different conditions, GPS transceiver 258 can determine a physical location for remote computer 200. In at least one embodiment, however, remote computer 200 may, through other components, provide other information that may be employed to determine a physical location of the mobile computer, including for example, a Media Access Control (MAC) address, IP address, and the like.

Human interface components can be peripheral devices that are physically separate from remote computer 200, allowing for remote input and/or output to remote computer 200. For example, information routed as described here through human interface components such as display 250 or keyboard 252 can instead be routed through network interface 232 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a mobile computer with such peripheral human interface components is a wearable computer, which might include a remote pico projector along with one or more cameras that remotely communicate with a separately located mobile computer to sense a user's gestures toward portions of an image projected by the pico projector onto a reflected surface such as a wall or the user's hand.

A mobile computer may include a browser application that is configured to receive and to send web pages, web-based messages, graphics, text, multimedia, and the like. The mobile computer's browser application may employ virtually any programming language, including a wireless application protocol messages (WAP), and the like. In at least one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 204 may include RAM, ROM, and/or other types of memory. Memory 204 illustrates an example of computer-readable storage media (devices) for storage of information such as computer-readable instructions, data structures, program modules, or other data. Memory 204 may store BIOS 208 for controlling low-level operation of remote computer 200. The memory may also store operating system 206 for controlling the operation of remote computer 200. It will be appreciated that this component may include a general-purpose operating system (e.g., a version of Microsoft Corporation's Windows or Windows Phone™, Apple Corporation's OSX™ or iOS™, Google Corporation's Android, UNIX, LINUX™, or the like). In other embodiments, operating system 206 may be a custom or otherwise specialized operating system. The operating system functionality may be extended by one or more libraries, modules, plug-ins, or the like.

Memory 204 may further include one or more data storage 210, which can be utilized by remote computer 200 to store, among other things, applications 220 and/or other data. For example, data storage 210 may also be employed to store information that describes various capabilities of remote computer 200. The information may then be provided to another device or computer based on any of a variety of events, including being sent as part of a header during a communication, sent upon request, or the like. Data storage 210 may also be employed to store social networking information including address books, buddy lists, aliases, user profile information, or the like. Data storage 210 may further include program code, data, algorithms, and the like, for use by a processor, such as processor 202 to execute and perform actions. In one embodiment, at least some of data storage 210 might also be stored on another component of remote computer 200, including, but not limited to, non-transitory processor-readable removable storage device 236, processor-readable stationary storage device 234, or even external to the mobile computer.

Applications 220 may include computer executable instructions which, when executed by remote computer 200, transmit, receive, and/or otherwise process instructions and data. Examples of application programs include, but are not limited to, calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth.

### Illustrative Speaker/Microphone System

FIG. 3 shows one embodiment of speaker/microphone system 300 that may include many more or less components than those shown. System 300 may represent, for example, at least one embodiment of speaker/microphone system 110 shown in FIG. 1. In various embodiments, system 300 may be remotely located (e.g., physically separate from) to another device, such as remote computer 200 of FIG. 2. While in other embodiments, system 300 may be combined with remote computer 200 of FIG. 2.

Although speaker/microphone system 300 is illustrated as a single device—such as a remote speaker system with hands-free telecommunication capability (e.g., includes a speaker, a microphone, and Bluetooth capability to enable a user to telecommunicate with others)—embodiments are not so limited. For example, in some other embodiments, speaker/microphone system 300 may be employed as multiple separate devices, such as a remote speaker system and a separate remote microphone that together may be operative to enable hands-free telecommunication. Although embodiments are primarily described as a smart phone utilizing a remote speaker with microphone system, embodiments are not so limited. Rather, embodiments described herein may be employed in other systems, such as, but not limited to sounds bars with phone call capability, home theater systems with phone call capability, mobile phones with speaker phone capability, automobile devices with hands-free phone call capability, or the like.

In any event, system 300 may include processor 302 in communication with memory 304 via bus 310. System 300 may also include power supply 312, input/output interface 320, speaker 322, microphone(s) 324, indicator(s) 326, activator(s) 328, processor-readable storage device 316. In some embodiments, processor 302 (in conjunction with memory 304) may be employed as a digital signal processor within system 300. So, in some embodiments, system 300 may include speaker 322, microphone(s) 324, and a chip (noting that such a system may include other components, such as a power supply, various interfaces, other circuitry, or the like), where the chip is operative with circuitry, logic, or other components capable of employing embodiments described herein.

Power supply 312 may provide power to system 300. A rechargeable or non-rechargeable battery may be used to provide power. The power may also be provided by an external power source, such as an AC adapter that supplements and/or recharges the battery.

Speaker 322 may be a loudspeaker or other device operative to convert electrical signals into audible sound. In some embodiments, speaker 322 may include a single loudspeaker, while in other embodiments, speaker 322 may include a plurality of loudspeakers (e.g., if system 300 is implemented as a soundbar).

Microphone(s) 324 may include one or more microphones that are operative to capture audible sounds and convert them into electrical signals. In some embodiments, microphone 324 may be a microphone array. In various embodiments, the microphone array may be physically positioned/configured/arranged on system 300 to logically define a physical space relative to system 300 into a plurality of listening regions, where each status for each listening region is logically defined as active or inactive.

In at least one of various embodiments, speaker 322 in combination with microphone array 324 may enable telecommunication with users of other devices.

System 300 may also comprise input/output interface 320 for communicating with other devices or other computers, such as remote computer 200 of FIG. 2, or other mobile/network computers. Input/output interface 320 can utilize one or more technologies, such as Universal Serial Bus (USB), Infrared, WiFi, WiMax, Bluetooth™, wired technologies, or the like.

Although not illustrated, system 300 may also include a network interface, which may operative to couple system 300 to one or more networks, and may be constructed for use with one or more communication protocols and technologies including, but not limited to, protocols and technologies that implement any portion of the OSI model, GSM, CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Such a network interface is sometimes known as a transceiver, transceiving device, or network interface card (NIC).

Memory 304 may include RAM, ROM, and/or other types of memory. Memory 304 illustrates an example of computer-readable storage media (devices) for storage of information such as computer-readable instructions, data structures, program modules, or other data. Memory 304 may further include one or more data storage 306. In some embodiments, data storage 306 may store, among other things, applications 308. In various embodiments, data storage 306 may include program code, data, algorithms, and the like, for use by a processor, such as processor 302 to execute and perform actions. In one embodiment, at least some of data storage 306 might also be stored on another component of system 300, including, but not limited to, non-transitory processor-readable storage 316.

Applications 308 may include speech enhancer 332. Speech enhancer 332 may be operative to provide various algorithms, methods, and/or mechanisms for enhancing speech received through microphone(s) 324. In various embodiments, speech enhancer 332 may employ various beam selections and combination techniques, beamforming techniques, noise cancellation techniques (for noise received through inactive regions), noise enhancement techniques (for signals received through active regions, or the like, or a combination thereof in accordance with embodiments described herein.

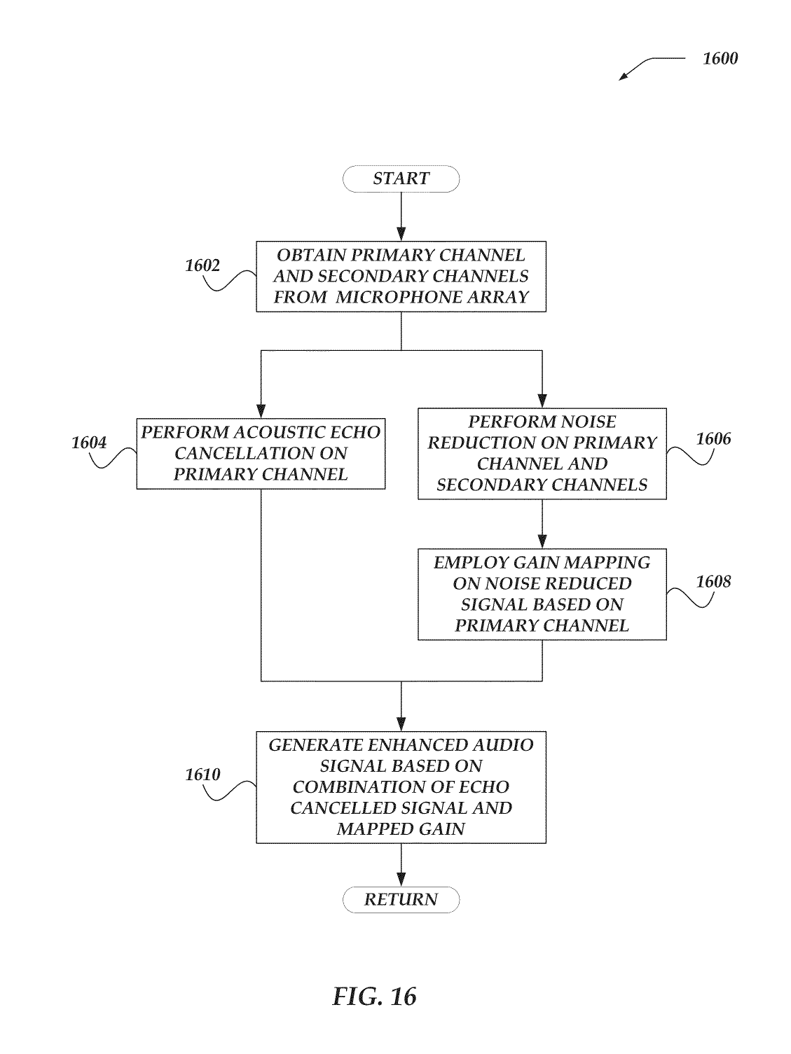

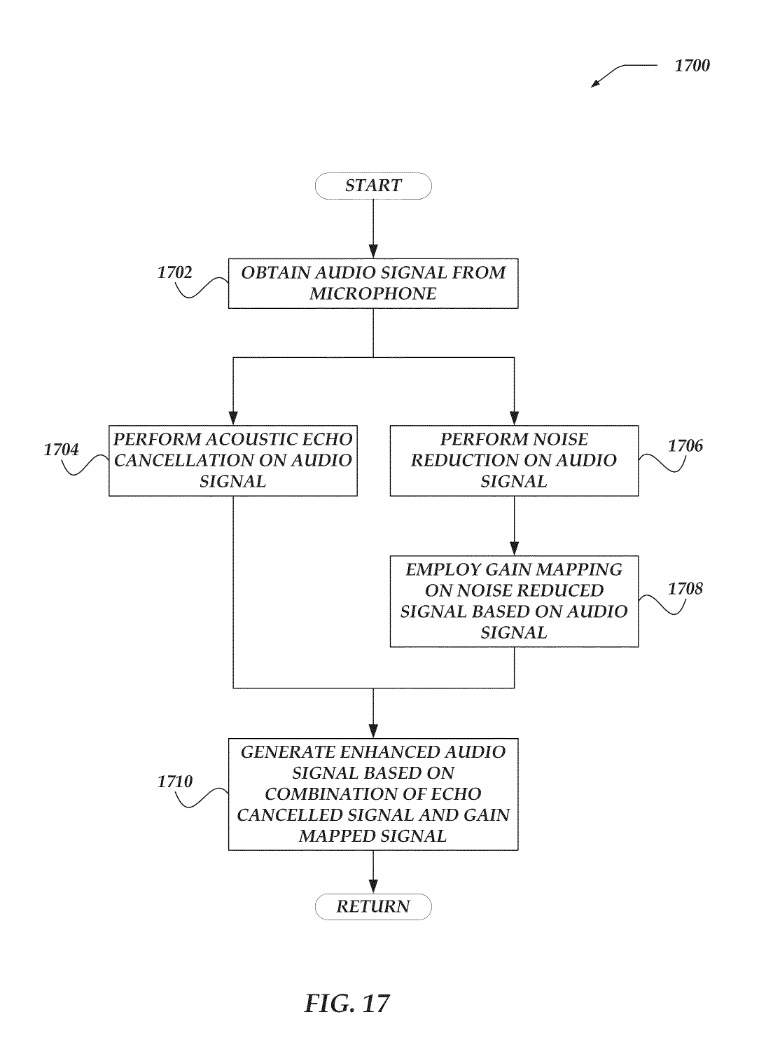

In some embodiments, hardware components, software components, or a combination thereof of system 300 may employ processes, or part of processes, similar to those described in conjunction with FIGS. 16 and 17.

### Illustrative Use Case Environments

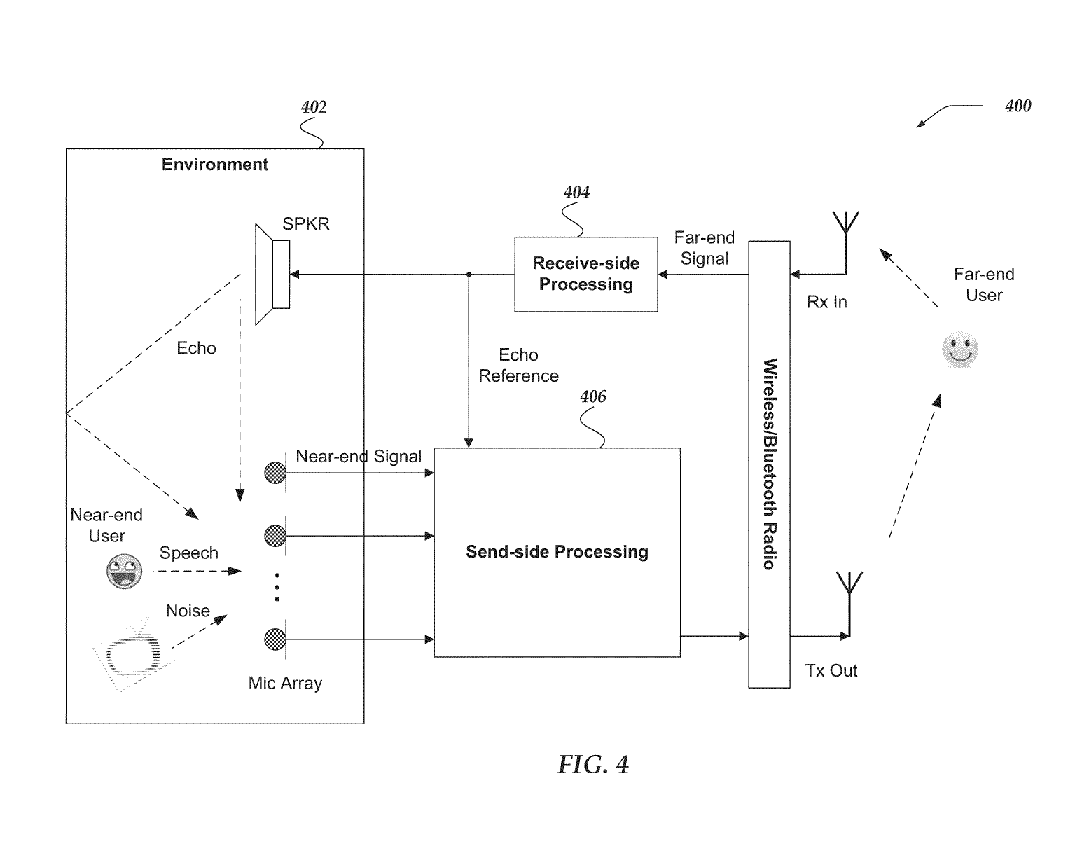

Speech enhancement technology is important for a voice communication application such as cellular phones, Bluetooth headsets, speakerphone, and voice recognition devices. FIG. 4 shows a typical voice communication system which has bi-directional speech processing between a near-end user and a far-end user. Bi-directional signal processing is also used to improve the quality of voice communication: receive-side processing (e.g., receive-side processing 404) for the far-end signal and send-side processing (e.g., send-side processing 406) for the near-end signal. Receive-side processing 404 may prepare an audio signal received from the far-end user's communication device prior to outputting the signal through the speaker. The output of the receive-side processing 404 may also be used as the echo reference for the send-side processing 406.

When the voice communication between the near-end user and the communication device (e.g., remote computer 200 of FIG. 2 and/or speaker/microphone system 300 of FIG. 3) is performed through the speaker and microphone, the reflections of the acoustic signal from the speaker (e.g., echoes) and the noises from the environment (e.g., environment 402) may be picked up by the microphone (or microphone array, as illustrated). Those undesirable signals are acoustically mixed with the speech from the near-end user, and thus the quality of the voice communication may be degraded. In general, send-side processing 406 should employ echo cancellation and noise suppression to enhance the speech from the near-end user. This cancellation and suppression typically occurs on the near-end user's communication device (e.g., remote computer 200 of FIG. 2 and/or speaker/microphone system 300 of FIG. 3) prior to sending the signal to the far-end user's communication device. In some embodiments, this cancellation and suppression may be performed by a speaker/microphone system prior to transmitting the received audio speech signal to the near-end user's remote computer. The near-end user's remote computer may then transmit the enhanced audio signal to the far-end user's communication device.

The technology for echo cancellation is often called acoustic echo cancellation or AEC. In a real application, the propagation paths for the echo reflections may change due to various factors, such as, but not limited to, movement of the user, volume changes on the speaker, environment changes, or the like. Therefore, adaptive filtering methods may be employed in the AEC to track the changes in the acoustic paths of echo. The AEC may include, but not limited to, a linear filter, a residual echo reducer, a non-linear processor, a comfort noise generator, or the like.

The technology to suppress the noise is often called noise reduction or NR. NR may be achieved using various techniques that are classified as single microphone techniques or multi microphone techniques.

Single microphone NR (1-Mic NR) techniques typically take advantage of the statistical differences of the spectra between speech and noise. These statistical model-based techniques can be effective in reducing stationary noise (e.g., consistent road noise, airplane noise, or the like), but may not be very effective in reducing non-stationary noise (e.g., such as babble, competing speech, music, or the like), which are often encountered in practical applications. Moreover, single microphone techniques may also cause distortion in the speech signal.

Multi microphone NR (M-Mic NR) techniques generally use an array of microphones that can explore the spatial differences between user's speech and noises, rather than the statistical difference used in the single microphone techniques. Beamforming is one (or part) of the M-Mic NR techniques that captures signal from a certain direction (or area), while rejecting or attenuating signals from other directions (or areas). A beamformer can reduce both stationary and non-stationary noise without distorting the speech. In a real application, the location of the user and the environment may change; so adaptive beamforming method may be employed to adjust its beampattern in order to track those changes.

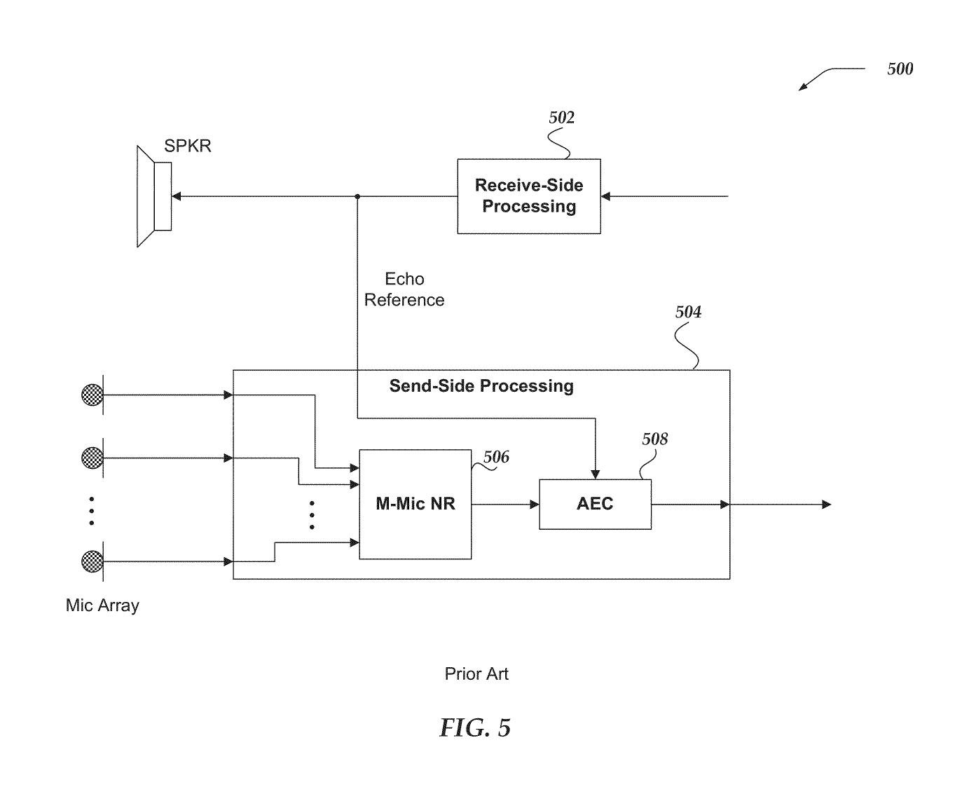

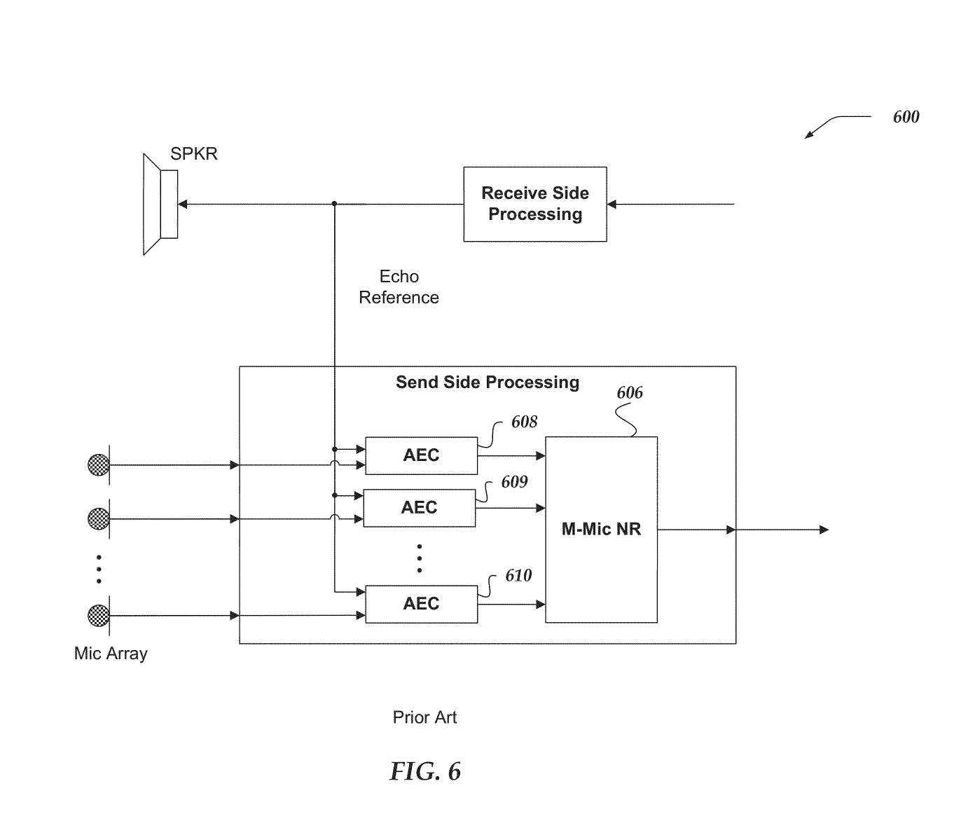

For high quality audio, AEC and M-Mic NR techniques may be combined in the send- side processing to provide full-duplex and noise-free (or near-noise free) voice communication. Traditionally, there are two structures to combine the acoustic echo canceller and multi microphone noise reduction, “M-Mic NR first” and “AEC first,” which are illustrated in FIGS. 5 and 6, respectively.

FIG. 5 illustrates a noise-reduction-first structure for enhancing audio signals. This structure may be referred to as “M-Mic NR first.” As illustrated, system 500 may include receive-side processing 502 and send-side processing 504. Receive-side processing 502 may be an embodiment of receive-side processing 404 of FIG. 4. Send-side processing 504 may include M-Mic NR 506 in series with AEC 508. M-Mic NR 506 may perform noise reduction using signals from a plurality of microphones (e.g., from the microphone array or mic array). AEC 508 may perform acoustic echo cancelation on the noise reduced signal that is output from M-Mic NR 506. So, the noise reduction techniques are applied first, followed by the echo cancelation techniques being applied to the output of the noise reduction.

The “M-Mic NR” method is relatively computational friendly but often requires continuous learning in the echo canceler due to changing characteristics of the beamformer in the M-Mic NR. Therefore, “M-Mic NR first” is generally used for mild echo applications. One such example application may be for a headset, where the power of echo is relatively weaker than that of the near-end signal. Other example applications may be applications with mild environment noise or fixed-location of user, such as teleconferencing, where beamformer can be fixed or semi-fixed and thus the adaptation of beamformer may not frequently or seriously interrupt the filters in AEC.

FIG. 6 illustrates an acoustic-echo-cancelation-first structure for enhancing audio signals. This structure may be referred to as “AEC first.” As illustrated, system 600 may include receive-side processing and send-side processing. The send-side processing may include M-Mic NR 606 and AEC 608-610.

M-Mic NR 606 may perform noise reduction similar to M-Mic NR 506 of FIG. 5. And each of AEC 608-610 may perform acoustic echo cancellation similar to AEC 508 of FIG. 5. Each of AEC 608-610 may perform acoustic echo cancelation on a separate input signal from the plurality of microphones. The output of each AEC 608-610 may be input into M-Mic NR 506, which may perform noise reduction using the echo canceled signals. So, the echo cancelation techniques are applied first to each separate input signal, followed by the noise reduction techniques being applied to the output of the echo canceled signals.

The “AEC first” system may provide better echo cancelation performance but is often computationally intensive as the echo cancelation is applied for every microphone in the microphone array. The computational complexity increases with an increase in the number of microphones in the microphone array. This computational complexity often limits the number of microphones used in a microphone array, which in turn reduces the benefit from the M-Mic NR algorithm with more microphones. So, computational complexity is often a trade-off for noise reduction performance.

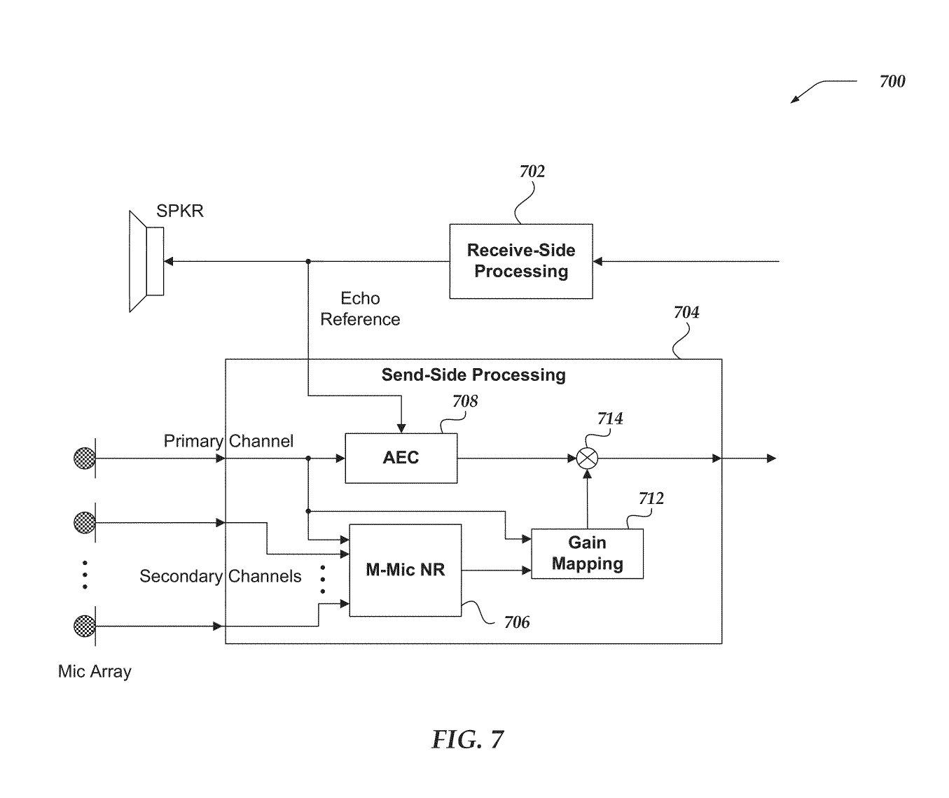

FIG. 7 illustrates an embodiment of a system that employs acoustic echo cancelation in parallel/simultaneously with noise reduction techniques. System 700 may include receive-side processing 702 and send-side processing 704. Receive-side processing 702 may employ embodiments of receive-side processing 404 of FIG. 4.

Send-side processing 704 may include AEC 708 and M-Mic NR 706. M-Mic NR 706 may perform various noise reduction techniques on the primary and the secondary channels, such as adaptive and/or fixed beamformer technologies, or other noise reduction technologies. Various beamforming techniques may include, but not limited to, U.S. patent application Ser. No. 13/842,911, entitled “METHOD, APPARATUS, AND MANUFACTURE FOR BEAMFORMING WITH FIXED WEIGHTS AND ADAPTIVE SELECTION OR RESYNTHESIS,” U.S. patent application Ser. No. 13/843254, entitled “METHOD, APPARATUS, AND MANUFACTURE FOR TWO-MICROPHONE ARRAY SPEECH ENHANCEMENT FOR AN AUTOMOTIVE ENVIRONMENT;” and patent application Ser. No. 13/666,101, entitled “ADAPTIVE MICROPHONE BEAMFORMING,” which are herein incorporated by reference.

AEC 708 may perform acoustic echo cancellation on the primary channel relative to an echo reference signal, which may include, but not limited to, a linear filter, a residual echo reducer, a non-linear processor, a comfort noise generator, or the like.

Unlike that which is illustrated in FIGS. 5 and 6 (in which the AEC and NR technologies are performed sequentially or in series), AEC 708 and M-Mic NR 706 are performed “simultaneously” or in parallel.

The signals received from the microphone array may include a single “primary channel” from one microphone and one or more “secondary channels” from any other microphones in the microphone array. In various embodiments, the primary channel is distinct and separate from the secondary channels, i.e., the primary channel is an audio signal received from one microphone in the microphone array and the secondary channels are audio signals received from the other microphones in the microphone array.

In various embodiments, the primary channel may be determined from a microphone array. In some embodiments, the primary channel may be a designated or primary microphone input. In other embodiments, the primary channel may not be a primary microphone input, but may be optimally selected in real-time from the plurality of microphones in the microphone array, such as illustrated below in conjunction with FIGS. 14 and 15A-15C.

In various embodiments, the primary channel may be input into AEC 708. AEC 708 may perform echo cancellation on the primary channel based on the echo reference signal output from receive-side processing 702. In at least one of various embodiments, AEC 708 may include a single AEC to cancel the echo from the primary channel. It should be noted that no other AEC is performed on the other microphone array signals (i.e., there is no AEC on the secondary channels).

The remaining signals from the microphone array may be referred to as “Secondary Channels.” In various embodiments, AEC will not be applied to the secondary channels. The secondary channels and the primary channel may be input into M-Mic NR 706. M-Mic NR 706 may process all the channels (to reduce the noise) simultaneously to AEC 708 processing the primary channel to cancel the speaker echo from the primary channel. So, unlike FIGS. 5 and 6 where the AEC(s) and M-Mic NR rely on the outputs from one another, AEC 708 and M-Mic NR 706 may operate independently of and without interference from one another. In at least one embodiment, only the secondary channel may be input into M-Mic NR 706.

Send-side processing 704 also includes gain mapping 712. Gain mapping 712 computes the “gain” between the output of M-Mic NR 706 and the primary channel. The resulting gain from gain mapping 712 may be applied (at element 714) to the output of AEC 708 to generate an enhanced audio signal (i.e., the output from send-side processing 704). In at least one of various embodiments, the gain may be multiplied by the output of AEC 708 to generate the enhanced audio signal. The output of element 714 may be the output signal from send-side processing 704 and provided to the far-end user. By mapping the total “effect” of M-Mic NR process into a single gain on the primary channel (which is then applied to the output of the AEC processing), the proposed structure enables M-Mic NR and AEC to work simultaneously and independently.

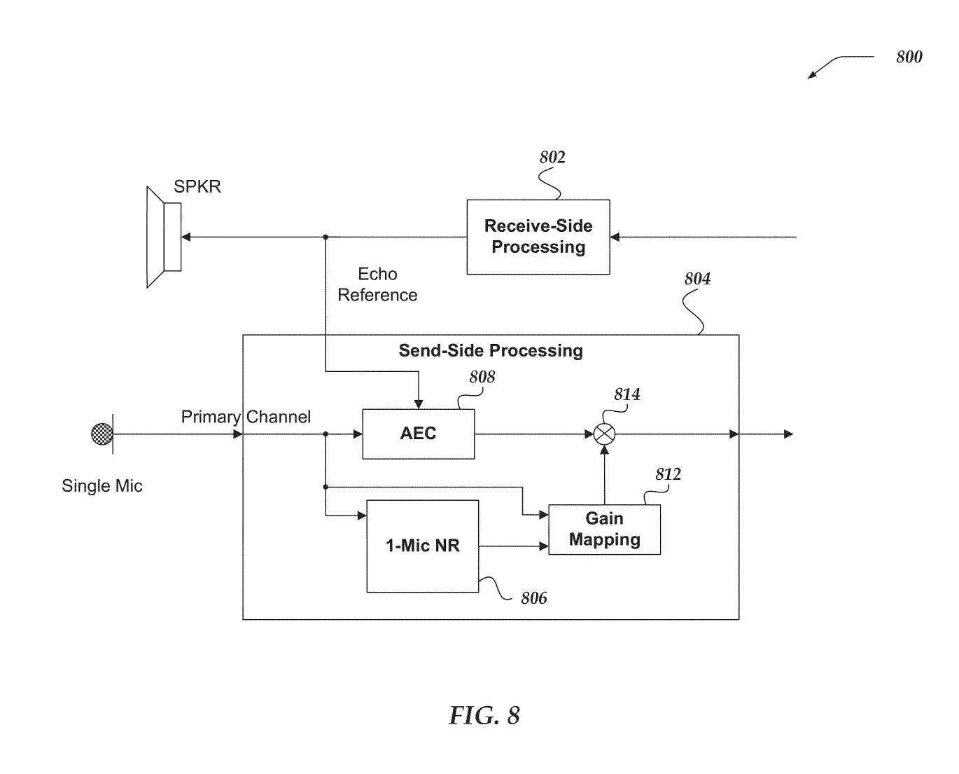

FIG. 8 illustrates an alternative embodiment of a system that employs acoustic echo cancelation in parallel/simultaneously with the noise reduction techniques. System 800 may employed embodiments of FIG. 7, but with a single microphone channel—compared to the multi-channel microphone array utilized in system 700 of FIG. 7. System 800 may include receive-side processing 802 and send-side processing 804. Receive-side processing 802 may be an embodiment of receive-side processing 702 of FIG. 7.

Similar to send-side processing 704 of FIG. 7, send-side processing 804 may include AEC 808, 1-Mic NR 806, and gain mapping 812. AEC 808 may be an embodiment of AEC 708 of FIG. 7, where the primary channel is input into AEC 808 for removal of the echoes based on the echo reference.

In contrast to the system illustrated in FIG. 7, system 800 may only utilize a primary channel and no secondary channels. In various embodiments, the primary channel may be input into 1-Mic NR 806 to reduce noise from the primary channel. Various single microphone noise reduction technologies may be employed. The output of 1-Mic NR and the primary channel may be input into gain mapping 812. Gain mapping 812 may employ embodiments of gain mapping 712 to create a single gain that can be applied to the output of AEC 808 at element 814 to generate the enhanced audio signal (i.e., the output of send-side processing 804). In various embodiments, element 814 may be an embodiment of element 714 of FIG. 7. The output of element 814 may be the output signal from send-side processing 804 and provided to the far-end user.

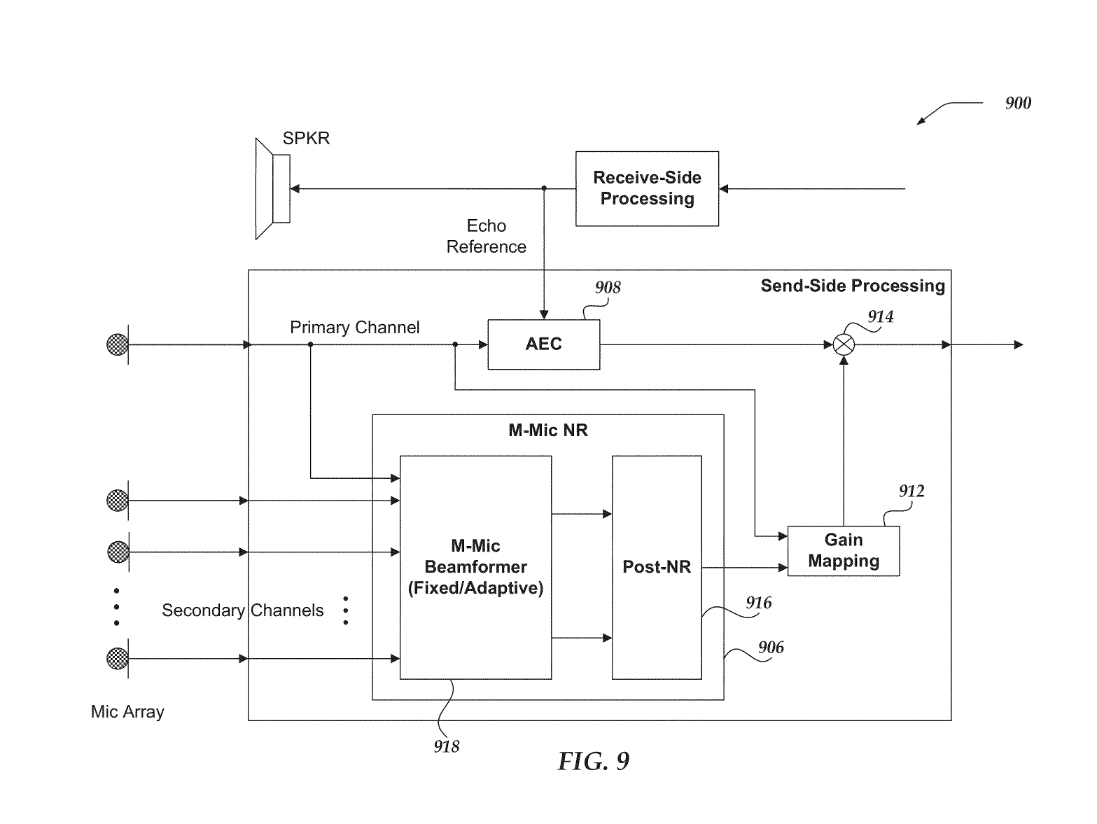

FIG. 9 illustrates an alternative embodiment of a system that employs acoustic echo cancelation in parallel/simultaneously with the noise reduction techniques. System 900 may be an embodiment of system 700 of FIG. 7, where AEC 908 may be an embodiment of AEC 708 of FIG. 7. M-Mic NR 906 may be composed of two sequentially connected sub-modules: M-Mic Beamformer 918 and Post-NR 916. The signals from the microphones in the microphone array (primary channel and secondary channels) may be provided to beamformer 918. Beamformer 918 can generate two outputs: a user speech dominated signal and a noise dominated signal. The Post-NR 916 module may perform further noise reduction on the speech dominated signal by using the two signals from the beamformer. The Post-NR 916 may include a noise canceller, a residual noise reducer, a two-channel Wiener filter, or the like.

The output of Post-NR 916 and the primary channel may be input into gain mapping 912. Gain mapping 912 may employ embodiments of gain mapping 712 to create a single gain that can be applied to the output of AEC 908 at element 914. In various embodiments, element 914 may be an embodiment of element 714 of FIG. 7. The output of element 914 may be the output signal from the send-side processing and provided to the far-end user.

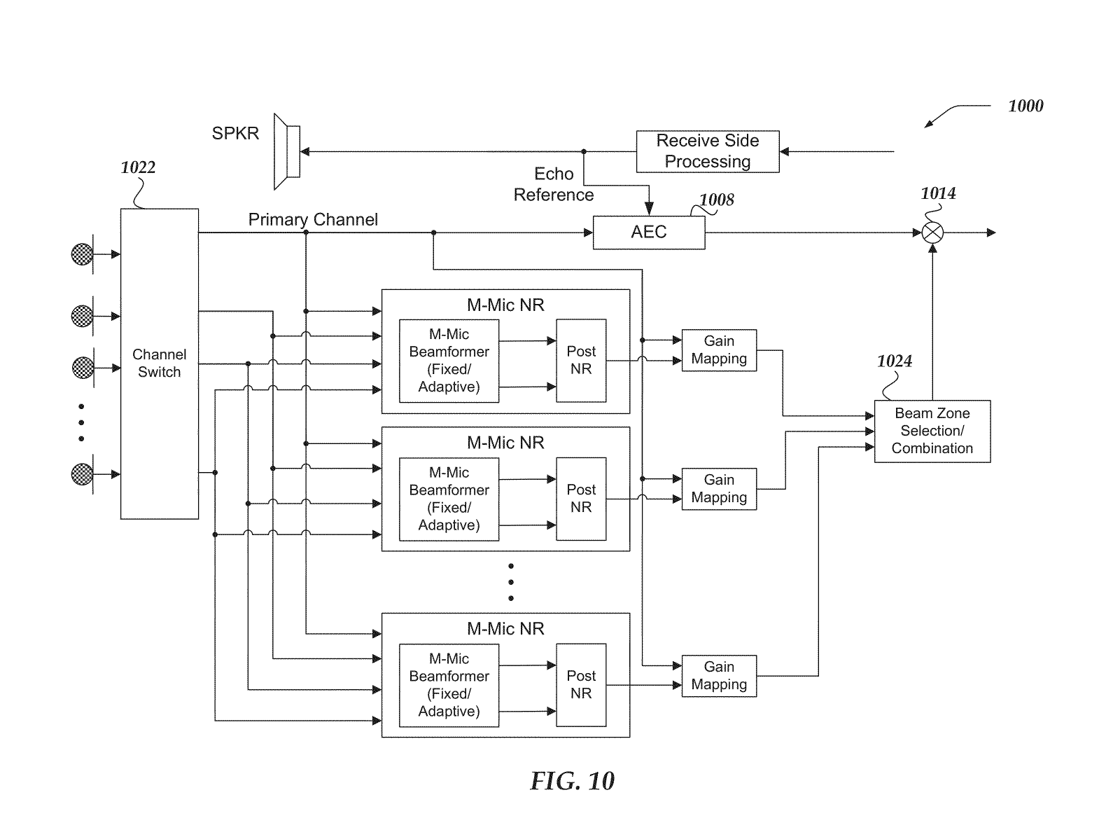

FIG. 10 illustrates an alternative embodiment of a system that employs acoustic echo cancelation in parallel/simultaneously with the noise reduction techniques. FIG. 9 illustrated a system that utilized a single beamformer. System 1000 of FIG. 10 illustrates a system that may utilize a plurality of beamformers. System 1000 may be an embodiment of system 900 of FIG. 9, where AEC 1008 may be an embodiment of AEC 908 of FIG. 9.

In various embodiments, a speaker/microphone system may logically separate its listening environment into a plurality of beam zones (or listening regions), such as illustrated in FIGS. 14 and 15A-15C. In various embodiments, one or more of the plurality of beam zones may be active while other beam zones may be inactive. Signals associated with an active zone may be enhanced and signals associated with an inactive zone may be suppressed from the resulting output signal.

System 1000 may include channel switch 1022. Channel switch 1022 may change which microphone signal is the primary channel and which microphone signals are the secondary signals. In various embodiments, the primary channel may be the signal from a microphone that is associated with an active beam zone. In some other embodiments, the criterion to select the primary channel may be from a pre-defined table or a run-time optimization algorithm which take into account of the echo power, signal to noise ratio, speakerphone placement, or the like.

System 1000 may include a separate M-Mic NR for each separate beam zone of the plurality of beam zones. Each microphone signal may be input into each separate M-Mic NR. Similar to that which is described above for FIG. 9, each M-Mic NR may be composed of two sequentially connected sub-modules: a M-Mic Beamformer and a Post-NR. The output of each M-Mic NR may be provided to a separate gain mapping module. The output of each gain mapping module may be provided to beam zone selection/combination component 1024.

Beam zone selection/combination component 1024 may select one or multiple zones as active and the rest zones as inactive. This selection may be based on a user's selection of active/inactive zone or may be automatic by tracking a user's speech from one zone to another. If one beam zone is active, its gain from the M-Mic NR module will be selected at beam zone selection/combination component 1024 and applied at element 1014 to the output of AEC 1008. If multi beam zones are active, the gains from those active zones may be combined (for example a maxima filter) at beam zone selection/combination component 1024 to generate a new gain that will be applied at element 1014 the output of AEC 1008. In various embodiments, element 1014 may be an embodiment of element 714 of FIG. 7. The output of element 1014 may be the output signal from the send-side processing and provided to the far-end user

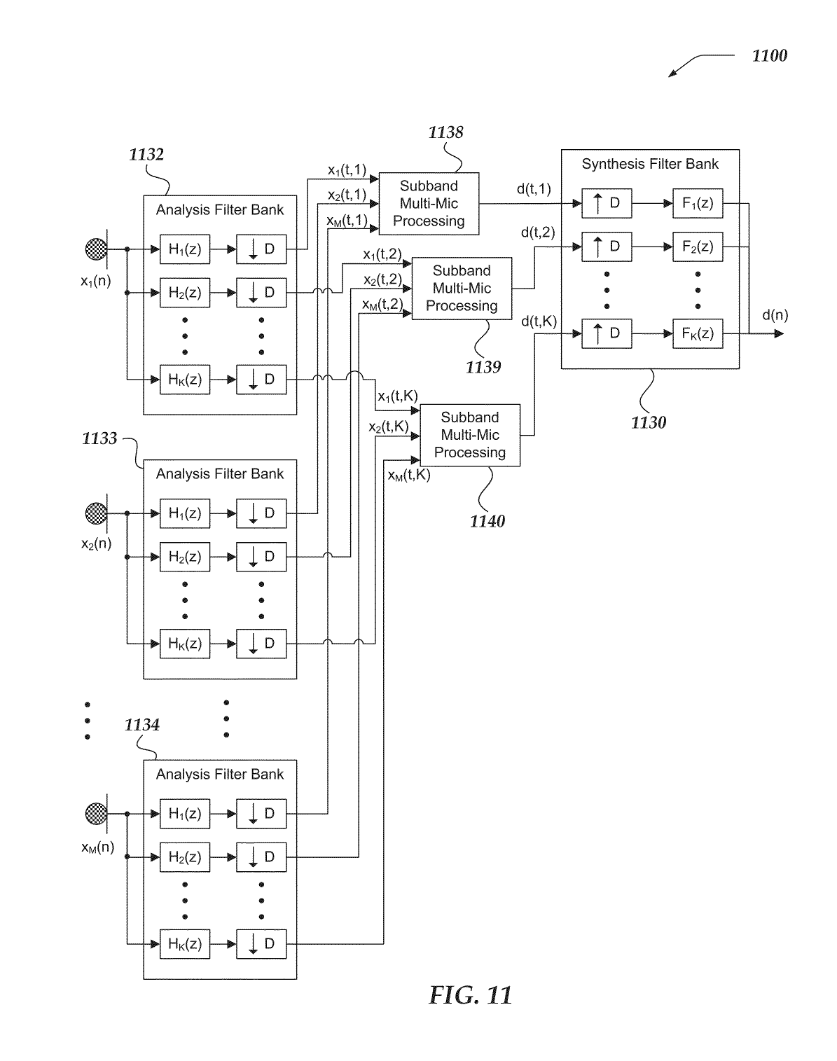

FIG. 11 illustrates an alternative embodiment of a system that employs acoustic echo cancelation in parallel/simultaneously with the noise reduction techniques. Various embodiments described herein may also be employed in the subband (or frequency) domain. Analysis filter banks 1132-1134 may be employed to decompose the discrete time-domain microphone signals into subbands. For each subband, the Multi-Mic processing described herein (e.g., parallel AEC and M-Mic NR, such as described in conjunction with send-side processing 704 of FIG. 7) may be implemented at components 1138-1140. After each subband is processed in accordance with embodiments described herein, synthesis filter bank 1130 may be employed to generate the time-domain output signal as the enhanced audio signal.

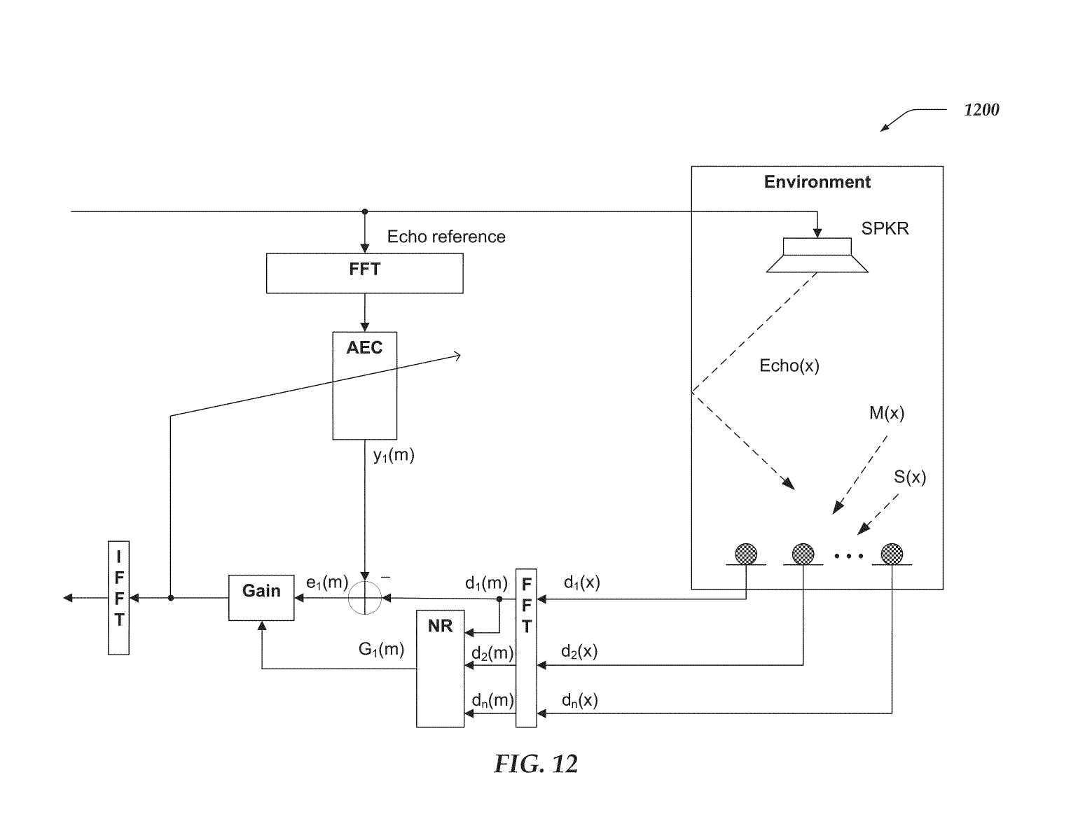

FIG. 12 illustrates an example schematic for employing noise reduction in parallel with acoustic echo cancellation in accordance with embodiments described herein. As described herein, an environment may include echo(x) from a speaker, m(x) from a target speech source, and s(x) from noise within the environment. Embodiments described herein attempt to enhance m(x) by reducing or removing s(x) and cancelling echo(x) from m(x). echo(x), m(x), and s(x) may be obtained through a microphone array as signals d₁(x), d₂(x), and dₙ(x). Each of these signals may be provided to an FFT to convert the signals into the frequency domain, resulting in d₁(m), d₂(m), and d₂(m), d₁(m), d₂(m), and dₙ(m) may be input into a noise reduction component, which may output G₁(m). In this example, d₁(m) may be the primary channel (which may also be referred to as the reference signal for the target speech from the microphone array).

In parallel with the noise reduction being determined, an echo reference may be converted to the frequency domain and provided to an AEC component. The output of the AEC component may be y₁(m). y₁(m) may then be subtracted from d₁(m) to produce e₁(m). e₁(m) and G₁(m) may be provided to a final gain component. The resulting gain may be the feedback to the AEC for adaptive filtering. The resulting gain may be described as G₁(m)=G₁(m)+μx₁(m)G₁(m)e₁(m). The resulting signal may then be converted back to the time domain.

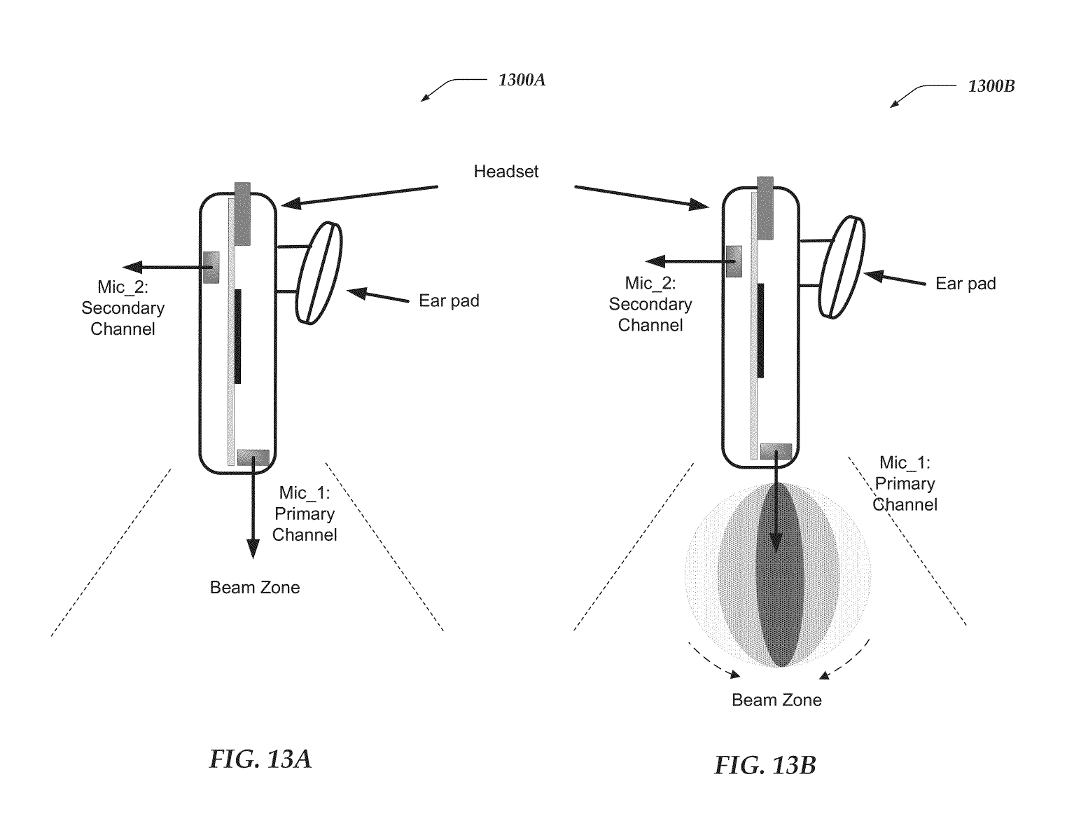

FIGS. 13A and 13B illustrate a hands-free headset using embodiment described herein. FIGS. 13A and 13B may be top, plan views of a hands-free headset. The headset may include an ear pad for support/stabilization within a user's ear. The ear pad may include the speaker. The headset may also include multiple microphones (e.g., Mic_1 and Mic_2). In these illustrations, Mic_1 may be the primary channel because it is closest to and directed towards a user's mouth while being farthest from the speaker. And Mic_2 may be a secondary channel for picking up noise from the user's environment.

In various embodiments, Mid_1 may be designed and positioned so that the relative direction of the user's speech to the microphone array on the headset is approximately fixed, e.g., as illustrated in FIG. 13A. A beamformer may then steer the listening beam of Mid_1 to a pre-specified “looking” direction, called Beam Zone, as illustrated in FIG. 13B. Within the pre-defined Beam Zone, the beamformer can either be fixed or adaptive when the user moves to different noisy environment. In this example, the system may employ one M-Mic NR module as described in FIG. 7 or 9 to utilize the single Beam Zone in generating an enhanced audio signal in accordance with embodiments described herein.

FIG. 13 illustrates an example use-case environment for employing embodiments described herein. Environment 1300 may include a hands-free communication system (e.g., speaker/microphone system 300 of FIG. 3) positioned in the center of a room. The speakerphone may be configured to have four separate regions (or beam zones), regions A, B, C, and D (although more or less regions may also be employed). As illustrated, region A may be active (represented by the green LED active-region indicators), and regions B, C, and D may be inactive (represented by the red LED inactive-region indicators. A plurality of microphones may be arranged to logically define the physical space into a plurality of regions or beam zones.

Embodiments described herein, such as illustrated in FIG. 10, may be employed to generate enhanced audio signals for active regions while reducing/cancelling noise from inactive regions. In various embodiments, the primary channel may be the audio signal generated from a microphone that corresponds to an active region or beam zone. And in some embodiments, the secondary channels may be the audio signals generated from microphones that correspond to inactive regions or beam zones.

The region that is active may change based on a user's manual selection of which region(s) are active or inactive (e.g., by pressing a button) or automatically selected based on one or more triggers (e.g., a spoken trigger word), which is described in more detail in U.S. patent application Ser. No. 14/328,574 and is herein incorporated by reference. If the active/inactive status of the regions change, then a different primary channel may be determined/selected based on a newly activated region. And a previous primary channel may become a secondary channel.

FIGS. 15A-15C illustrate another example use-case environment for employing embodiments described herein. Environments 1500A-1500C may be similar to environment 1300 of FIG. 13 but with two regions or beam zones. This environment may be for an automobile, where a driver and front-passenger may be target users positioned in different regions. By employing embodiments described herein the system may target speech from only the driver (as illustrated in FIG. 15A), only the passenger (as illustrated in FIG. 15B), or from the driver and passenger (as illustrated in FIG. 15C).

### General Operation

Operation of certain aspects of the invention will now be described with respect to FIGS. 16 and 17. In at least one of various embodiments, at least a portion of processes 1600 and 1700 described in conjunction with FIGS. 16 and 17, respectively, may be implemented by and/or executed on one or more network computers, such as speaker/microphone system 300 of FIG. 3. Additionally, various embodiments described herein can be implemented in a system such as system 100 of FIG. 1.

FIG. 16 illustrates a logical flow diagram generally showing an embodiment of a process for generating an enhanced audio signal by employing AEC and NR in parallel. Process 1600 may begin, after a start block, at block 1602, where a primary channel and one or more secondary channels may be obtained from a microphone array. In various embodiments, the primary channel may be the audio signal generated by a primary microphone. In other embodiments, the primary channel may be the audio signal generated from a dynamically selected microphone in the microphone array, such as a microphone associated with an active region or beam zone. The secondary channel(s) may be audio signal(s) generated from other microphones in the microphone array but not the same microphone that generated the primary channel.

Process 1600 may split and perform blocks 1604 in parallel or simultaneously with blocks 1606 and 1608.

At block 1604, acoustic echo cancellation may be performed on the primary channel. Various AEC techniques may be employed on the primary channel to generate an echo canceled signal. In various embodiments, an echo reference signal (e.g., a same signal as output through a speaker) may be utilized to cancel echoes from the primary channel. After block 1604, process 1600 may flow to block 1610.

At block 1606, noise reduction may be performed on the primary channels and the secondary channels. Various multi-microphone noise reduction techniques may be employed on the primary and secondary channels to generate a noise reduced signal.

Process 1600 may flow from block 1606 to block 1608, where a gain mapping may be employed on the noise reduced signal based on the primary channel. After block 1608, process 1600 may flow to block 1610.

At block 1610, an enhanced audio signal may be generated based on a combination of the echo canceled signal and the mapped gain. In various embodiments, the mapped gain may be multiplied by the echo canceled signal to create the enhanced audio signal. In various embodiments, the resulting enhanced audio signal may be output and provided to a far-end user's communication device.

After block 1610, process 1600 may terminate and/or return to a calling process to perform other actions.

FIG. 17 illustrates a logical flow diagram generally showing an alternative embodiment of a process for generating an enhanced audio signal by employing AEC and NR in parallel. Process 1700 may employ embodiments similar to those described in conjunction with process 1600 of FIG. 16, but utilizing only a primary channel and no secondary channels.

Process 1700 may begin, after a start block, at block 1702, where an audio signal may be obtain from a microphone. Process 1700 may split and perform blocks 1704 in parallel or simultaneously with blocks 1706 and 1708.

At block 1704, acoustic echo cancellation may be performed on the audio signal. Various AEC techniques may be employed on the audio signal to generate an echo canceled signal. In various embodiments, an echo reference signal (e.g., a same signal as output through a speaker) may be utilized to cancel echoes from the audio signal. After block 1704, process 1700 may flow to block 1710.

At block 1706, noise reduction may be performed on the audio signal. Various single microphone noise reduction techniques may be employed on the audio signal to generate a noise reduced signal.

Process 1700 may flow from block 1706 to block 1708, where a gain mapping may be employed on the noise reduced signal based on the audio signal. In various embodiments, block 1708 may employ embodiments of block 1608 of FIG. 16 to perform gain mapping on the noise reduced signal. After block 1708, process 1700 may flow to block 1710.

At block 1710, an enhanced audio signal may be generated based on a combination of the echo canceled signal and the mapped gain. In various embodiments, block 1710 may employ embodiments of block 1610 to generate the enhanced audio signal.

After block 1710, process 1700 may terminate and/or return to a calling process to perform other actions.

It should be understood that the embodiments described in the various flowcharts may be executed in parallel, in series, or a combination thereof, unless the context clearly dictates otherwise. Accordingly, one or more blocks or combinations of blocks in the various flowcharts may be performed concurrently with other blocks or combinations of blocks. Additionally, one or more blocks or combinations of blocks may be performed in a sequence that varies from the sequence illustrated in the flowcharts.

Further, the embodiments described herein and shown in the various flowcharts may be implemented as entirely hardware embodiments (e.g., special-purpose hardware), entirely software embodiments (e.g., processor-readable instructions), user-aided, or a combination thereof. In some embodiments, software embodiments can include multiple processes or threads, launched statically or dynamically as needed, or the like.

The embodiments described herein and shown in the various flowcharts may be implemented by computer instructions (or processor-readable instructions). These computer instructions may be provided to one or more processors to produce a machine, such that execution of the instructions on the processor causes a series of operational steps to be performed to create a means for implementing the embodiments described herein and/or shown in the flowcharts. In some embodiments, these computer instructions may be stored on machine- readable storage media, such as processor-readable non-transitory storage media.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A method for enhancing speech and noise reduction for audio signals, comprising:
employing each of a plurality of microphones to generate a plurality of audio signals based on sound sensed in a physical space, wherein one of the plurality of audio signals is a primary channel and each other audio signal of the plurality of audio signals are secondary channels;
performing acoustic echo cancellation on the primary channel to generate an echo canceled signal;
performing noise reduction on the primary channel and the secondary channels to generate a noise reduced signal, wherein the noise reduction is performed in parallel with the acoustic echo cancellation; and
generating an enhanced audio signal based on a combination of the echo canceled signal and the noise reduced signal.

2. The method of claim 1, wherein generating the enhanced audio signal further comprises:
employing a gain mapping on the noise reduced signal compared to the primary channel; and
combining the mapped gain with the echo canceled signal to generate the enhanced audio signal.

3. The method of claim 1, further comprising:
determining the primary channel as an audio signal generated from a microphone that corresponds to an active beam zone within the physical space, wherein the plurality of microphones are arranged to logically define the physical space into a plurality of beam zones.

4. The method of claim 1, further comprising:
determining the secondary channels as audio signals are generated by one or more microphones that correspond to inactive beam zones within the physical space, wherein the plurality of microphones are arranged to logically define the physical space into a plurality of beam zones.

5. The method of claim 1, wherein performing noise reduction on the primary channel and the secondary channels, further comprises, employing a multi-microphone beamformer to generate the noise reduced signal.

6. The method of claim 1, wherein performing noise reduction on the primary channel and the secondary channels, further comprises:
employing a multi-microphone beamformer for each of a plurality of beam zones;
employing a separate gain mapping on each output from each multi-microphone beamformer to generate a mapped gain for each beam zone; and
selecting a final mapped gain from the mapped gain for each beam zone based on an active zone in the plurality of beam zones.

7. The method of claim 1, wherein performing noise reduction on the primary channel and the secondary channels to generate the noise reduced signal, further comprises, employing single microphone noise reduction on the primary channel without the secondary channels.

8. A computer for enhancing speech and noise reduction for audio signals, comprising:
a memory for storing at least instructions; and
a processor that executes the instructions to perform actions, including:
employing each of a plurality of microphones to generate a plurality of audio signals based on sound sensed in a physical space, wherein one of the plurality of audio signals is a primary channel and each other audio signal of the plurality of audio signals are secondary channels;
performing acoustic echo cancellation on the primary channel to generate an echo canceled signal;
performing noise reduction on the primary channel and the secondary channels to generate a noise reduced signal, wherein the noise reduction is performed in parallel with the acoustic echo cancellation; and
generating an enhanced audio signal based on a combination of the echo canceled signal and the noise reduced signal.

9. The computer of claim 8, wherein generating the enhanced audio signal further comprises:
employing a gain mapping on the noise reduced signal compared to the primary channel; and
combining the mapped gain with the echo canceled signal to generate the enhanced audio signal.

10. The computer of claim 8, wherein the processor that executes the instructions performs further actions, comprising:
determining the primary channel as an audio signal generated from a microphone that corresponds to an active beam zone within the physical space, wherein the plurality of microphones are arranged to logically define the physical space into a plurality of beam zones.

11. The computer of claim 8, wherein the processor that executes the instructions performs further actions, comprising:
determining the secondary channels as audio signals are generated by one or more microphones that correspond to inactive beam zones within the physical space, wherein the plurality of microphones are arranged to logically define the physical space into a plurality of beam zones.

12. The computer of claim 8, wherein performing noise reduction on the primary channel and the secondary channels, further comprises, employing a multi-microphone beamformer to generate the noise reduced signal.

13. The computer of claim 8, wherein performing noise reduction on the primary channel and the secondary channels, further comprises:
employing a multi-microphone beamformer for each of a plurality of beam zones;
employing a separate gain mapping on each output from each multi-microphone beamformer to generate a mapped gain for each beam zone; and
selecting a final mapped gain from the mapped gain for each beam zone based on an active zone in the plurality of beam zones.

14. The computer of claim 8, wherein performing noise reduction on the primary channel and the secondary channels to generate the noise reduced signal, further comprises, employing single microphone noise reduction on the primary channel without the secondary channels.

15. A processor readable non-transitory storage media that includes instructions to enhance speech and noise reduction for audio signals, wherein the execution of the instructions by a processor performs actions, comprising:
employing each of a plurality of microphones to generate a plurality of audio signals based on sound sensed in a physical space, wherein one of the plurality of audio signals is a primary channel and each other audio signal of the plurality of audio signals are secondary channels;
performing acoustic echo cancellation on the primary channel to generate an echo canceled signal;
performing noise reduction on the primary channel and the secondary channels to generate a noise reduced signal, wherein the noise reduction is performed in parallel with the acoustic echo cancellation; and
generating an enhanced audio signal based on a combination of the echo canceled signal and the noise reduced signal.

16. The media of claim 15, wherein generating the enhanced audio signal further comprises:
employing a gain mapping on the noise reduced signal compared to the primary channel; and
combining the mapped gain with the echo canceled signal to generate the enhanced audio signal.

17. The media of claim 15, further comprising:
determining the primary channel as an audio signal generated from a microphone that corresponds to an active beam zone within the physical space, wherein the plurality of microphones are arranged to logically define the physical space into a plurality of beam zones.

18. The media of claim 15, further comprising:
determining the secondary channels as audio signals are generated by one or more microphones that correspond to inactive beam zones within the physical space, wherein the plurality of microphones are arranged to logically define the physical space into a plurality of beam zones.

19. The media of claim 15, wherein performing noise reduction on the primary channel and the secondary channels, further comprises, employing a multi-microphone beamformer to generate the noise reduced signal.

20. The media of claim 15, wherein performing noise reduction on the primary channel and the secondary channels, further comprises:
employing a multi-microphone beamformer for each of a plurality of beam zones;
employing a separate gain mapping on each output from each multi-microphone beamformer to generate a mapped gain for each beam zone; and
selecting a final mapped gain from the mapped gain for each beam zone based on an active zone in the plurality of beam zones.
